(19) United States
(12) Patent Application Publication
(10) Pub. No.: US 2003/0012281 A1
(43) Pub. Date: Jan. 16, 2003

(54) Motion estimation apparatus and method for scanning an reference macroblock window in a search area

(75) Inventors: Jin-Hyun Cho, Kyungki-do (KR); Hyung-Lae Roh, Kyungki-do (KR); Yun-Tae Lee, Seoul (KR); Byeung-Woo Jeon, Kyungki-do (KR)

Correspondence Address: MARGER JOHNSON & McCOLLOM, P.C., 1030 S.W. Morrison Street, Portland, OR, 97205, US

(73) Assignee: Samsung Electronics Co., Ltd., Suwon-city (KR)

(21) Appl. No.: 10/112,011

(22) Filed: Mar. 29, 2002

(30) Foreign Application Priority Data
Jul. 9, 2001 (KR) 2001-40904

(51) Int. Cl. H04N 7/12

(52) U.S. Cl. 375/240.16; 348/699; 375/240.24; 375/240.12

(57) ABSTRACT

A motion estimation technique compares a current macroblock with different reference macroblocks in a reference frame search area. A motion vector for the current macroblock is derived from the reference macroblock most closely matching the current macroblock. To reduce the number of instructions required to load new reference macroblocks, overlapping portions between reference macroblocks are reused and only nonoverlapping portions are loaded into a memory storage device.

### BACKGROUND

This application relies for priority upon Korean Patent Application No. 2001-40904, filed on Jul. 9, 2001, the contents of which are herein incorporated by reference in their entirety.

Video encoders generate bit streams that comply with International standards for video compression, such as H.261, H.263, MPEG-1, MPEG-2, MPEG-4, MPEG-7, and MPEG-21. These standards are widely applied in the fields of data storage, Internet based image service, entertainment, digital broadcasting, portable video terminals, etc.

Video compression standards use motion estimation where a current frame is divided into a plurality of macroblocks (MBs). Dissimilarities are computed between a current MB and other reference MBs existing in a search area of a reference frame. The reference MB in the search area most similar to the current MB is referred to as the “matching block” and is selected. A motion vector is encoded for the current MB that indicates a phase difference between the current MB and the matching block. The phase difference refers to the location difference between the current MB and the matching block. Since only the motion vector for the current MB is transmitted, a smaller amount of data has to be transmitted or stored.

The relationship between the current MB and a search area is shown in FIG. 1. According to a Quarter Common Intermediate Format (QCIF), one frame consists of 176×144 pixels, a current frame 2 consists of 99 current MBs, and each current MB 10 consists of 16×16 pixels. A motion vector is computed for the current MB 10 in the reference frame 4. A search area 12 in the reference frame 4 includes 48×48 pixels.

In the search area 12, a 16×16 reference MB that is most similar to the current MB 10 is identified as the matching block. The differences between the current MB and the reference MBs can be computed by a variety of different methods. For example by using the Mean of the Absolute Difference (MAD), the Mean of the Absolute Error (MAE), or the Sum of the Absolute Difference (SAD). The SAD is most popular because it only requires subtraction and accumulation operations.

FIG. 2 shows a basic full search in which each pixel 10_1 and 14_1 are loaded into 32-bit registers 15 and 17, respectively. The SAD is then computed using an Arithmetic Logic Unit (ALU) 30. Both the current MB 10 and the reference MB 14a are stored in a memory and loaded into the 32-bit registers 15 and 17 pixel by pixel before being compared by the ALU 30. Reference MBs 14a, 14b, 14c, . . . etc. existing in the search area 12 are compared with the current MB 10 on a pixel by pixel basis.

This simple ideal estimation method provides high accuracy. However, the transmission rate is restricted because there are so many computations. This method is also unsuitable for real-time encoding with some general purpose Central Processing Units (CPUs) limited processing capacity, such as some CPUs used in hand held Personal Computers (PCs).

A fast search method algorithm (not shown) is used to compute the SAD by comparing a current MB with only a limited number of the reference MBs in the search area. This fast search algorithm can dramatically reduce the number of computations compared to the full search method described above. However, the fast search algorithm has reduced picture quality.

A quick computation of the SAD has been developed using a full search method. The SAD for a plurality of pixels is computed at the same time using a Single Instruction Multiple Data (SIMD) method. This reduced number of operations improves the transmission rate.

FIG. 3 illustrates the computation of the SAD using a SIMD device. Eight pixels 10_8 and 14_8 for the current MB 10 and reference MB 14a, respectively, are loaded into 64-bit registers 16 and 18, respectively. The SIMD machine 20 computes SAD for eight pixels loaded into each of the 64-bit registers 16 and 18 at the same time. Unlike a typical full search algorithm in which the SAD is separately computed for each pixel, a simultaneous parallel computation of the SAD for a plurality of pixels is achieved using the SIMD technique.

The amount of computation varies depending on the direction the next MB is shifted in the search area 12. As shown in FIG. 3, whenever a next MB is selected by horizontal shifting, 8 pixels in both the current MB 10 and the reference MB 14 must be accessed from memory and loaded into the registers 16 and 18. This large number of memory accesses increases the amount of time required for deriving motion vectors and increases power consumption.

These conventional motion estimation methods are unsuitable in mobile environments because of the large number of memory accesses and associated large power consumption. The present invention addresses this and other problems associated with the prior art.

### SUMMARY OF THE INVENTION

A motion estimation technique compares a current macroblock with different reference macroblocks in a reference frame search area. A motion vector for the current macroblock is derived from the reference macroblock most closely matching the current macroblock. To reduce the number of instructions required to load new reference macroblocks, overlapping portions between reference macroblocks are reused and only nonoverlapping portions are loaded into a memory storage device.

The foregoing and other objects, features and advantages of the invention will become more readily apparent from the following detailed description of a preferred embodiment of the invention which proceeds with reference to the accompanying drawings.

### BRIEF DESCRIPTION OF THE DRAWINGS

FIG. 1 is a prior art diagram showing how a motion vector is derived.

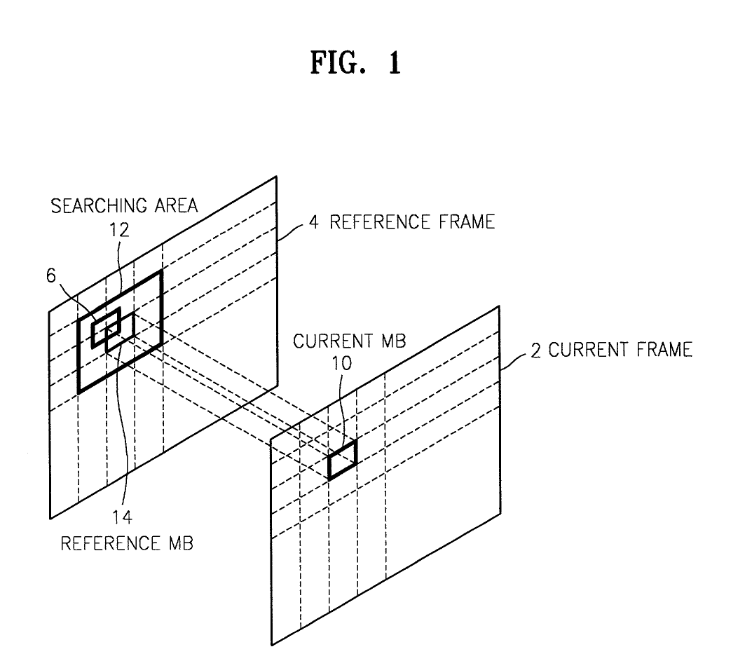

FIG. 2 is a prior art diagram illustrating a conventional method for performing a motion vector search using Sum of the Absolute Difference (SAD) using full search method.

FIG. 3 is a prior art diagram showing a conventional method for performing a motion vector search using a Single Instruction Multiple Data (SIMD) method.

FIG. 4 is a block diagram of a system for performing motion estimation according to the present invention.

FIG. 5 is a diagram of a decimation filter.

FIG. 6 is a diagram showing a current macroblock and a corresponding search area after decimation.

FIG. 7 is a diagram showing how two groups of registers are used according to the invention.

FIG. 8 shows how a reference macroblock is shifted in a search area according to the invention.

FIG. 9 is a flowchart showing how motion vectors are identified according to the invention.

FIGS. 10A-10D are charts comparing instruction counts for different motion estimation techniques.

FIGS. 11A-11D show other differences between conventional motion estimation methods and motion estimation according to the present invention.

FIG. 12 compares a vertical scanning technique according to the invention with other scanning techniques and shows the difference in memory access.

FIG. 13 shows conceptually a part of the dissimilarity computing unit 110 of FIG. 4.

### DETAILED DESCRIPTION OF THE INVENTION

The present invention provides efficient motion estimation that reduces memory accesses by reusing common registers when scanning reference MBs in a search area.

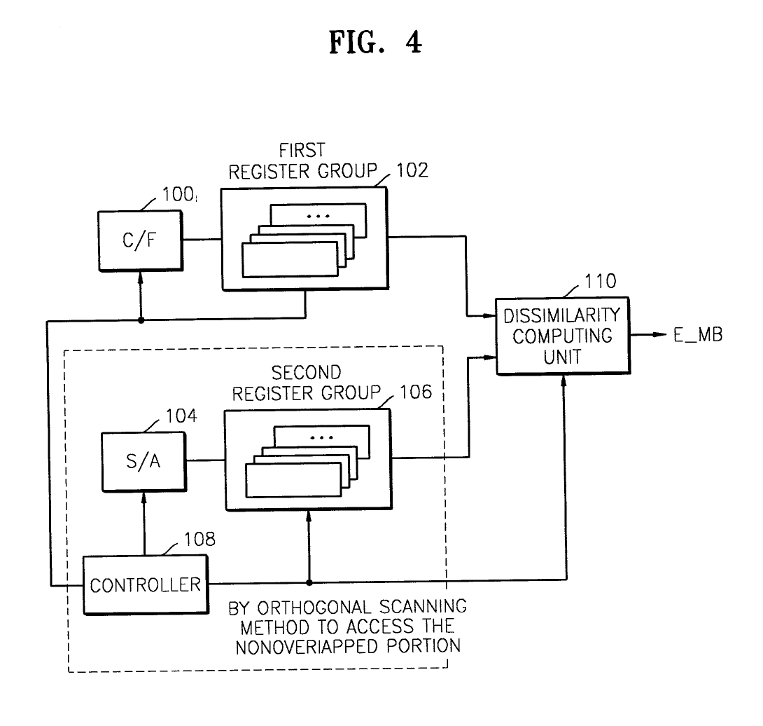

FIG. 4 is a block diagram of the preferred embodiment of a motion estimation system according to the present invention. The motion estimation system includes a current frame (C/F) 100, a first register group 102, a dissimilarity computing unit 110, a search area (S/A) 104, a second register group 106, and a controller 108. The first and second register groups 102 and 106 store pixels for one macroblock (MB) of the current frame 100 and one macroblock of the search area 104, respectively. In one example, the size of one MB is 16×16 pixels. Each of the first and second register groups 102 and 106 can store an array of 16×16 pixels. The controller 108 may be constructed by software or hardware.

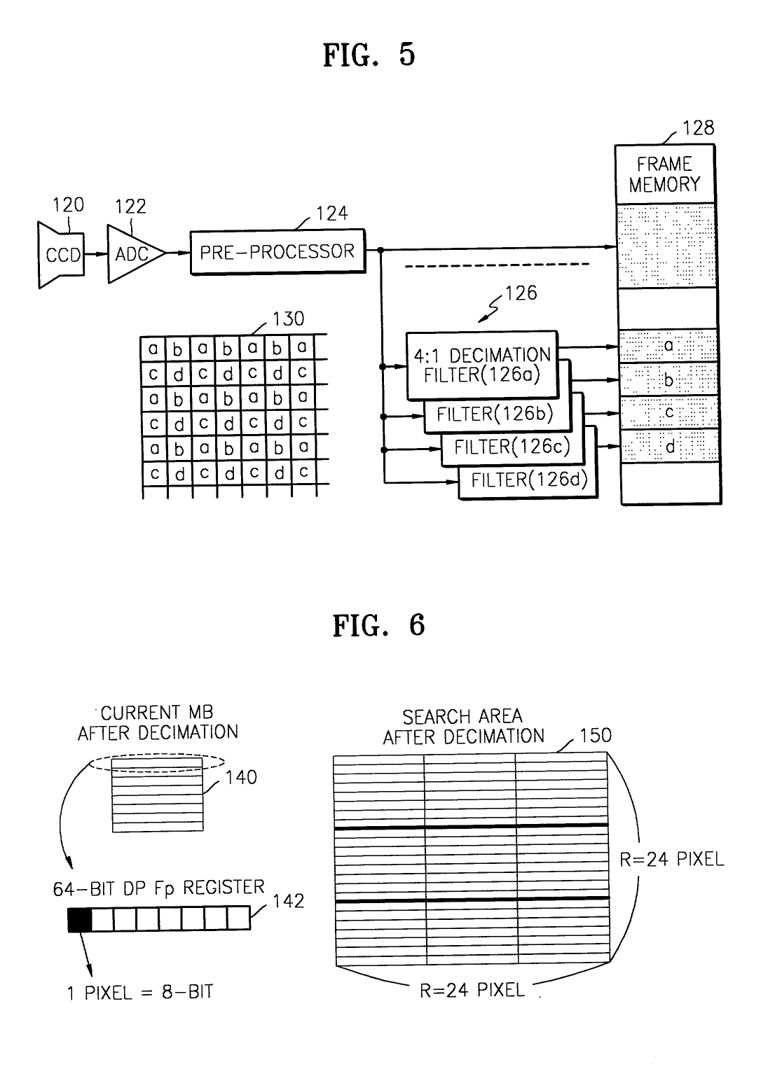

FIG. 5 shows a pre-process step carried out using 4:1 decimation filters. A n:1 decimation filer is used on the current frame 100 (FIG. 4) to reduce required hardware resources. The current frame is represented by input frame 130 in FIG. 5. Frame 130 is divided into four decimation frames a, b, c and d by four 4:1 decimation filters 126a, 126b, 126c and 126d, and stored in a frame memory 128. A video signal output from a charge coupled image capture device (CCD) 120 is converted into digital signals through an Analog-to-Digital Converter (ADC) 122. The signal output from the ADC 122 is a RGB signal. A pre-processor 124 converts the RGB signal to a YCbCr signal. In one embodiment, only the Y signal is subjected to decimation by the decimation filter 126.

The decimation filter 126a is for pixels a in the input frame 130, the decimation filter 126b is for pixels b, the decimation filter 126c is for pixels c, and the decimation filter 126d is for pixels d. After the decimation, decimated frames a, b, c, and d are stored in the frame memory 128.

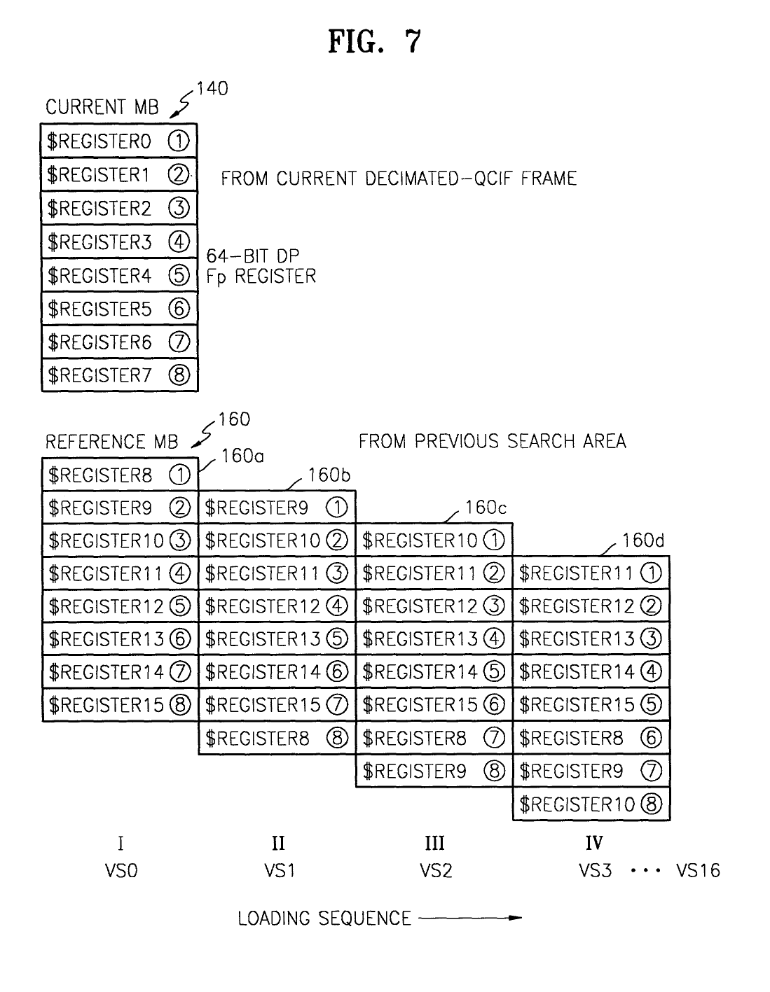

As a result of the 4:1 decimation for the input frame 130, the size of one MB reduces to 8×8 pixels. The search area 104 is decimated in the same ratio as the current frame 130. For example, 4:1 decimation for a search area of 48×48 pixels reduces the size of the search area to 24×24 pixels. FIG. 6 shows one current MB 140 and a corresponding search area 150 after 4:1 decimation.

For convenience of explanation, the current frame is described as one of the four decimation frames a, b, c, and d passed through the 4:1 decimation filters of FIG. 5. The size of each MB in the current frame 100 has a size of 8×8 pixels and the search area 104 after being passed through the 4:1 decimation filters has a size of 24×24 pixels.

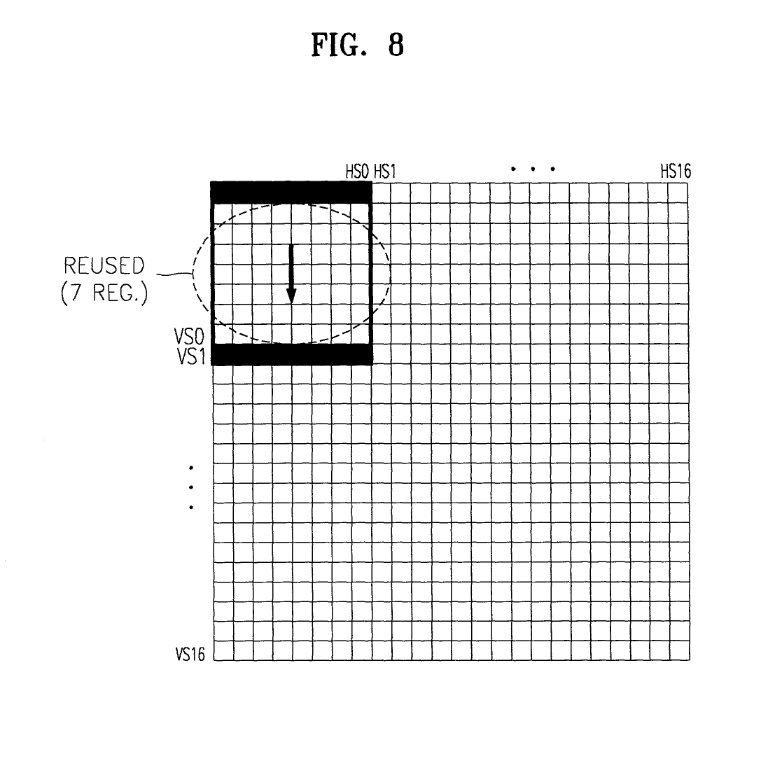

The first register group 102 (FIG. 4) stores one current MB of the current frame 100, and the second register group 106 stores one reference MB of the search area 104. The first and second register groups 102 and 106 store the pixels in a predetermined order showed as the circled numbers in FIG. 7. The computing order in each of the first and second register groups 140 and 160 is determined for groups of 8 pixels.

FIG. 7 shows the structures and loading sequences of the first and second register groups 102 and 106 in FIG. 4. The first register group 140 stores the current MB and includes registers each storing eight pixels. The registers are designated in a predetermined order from 0 to 7. The second register group 160 includes registers each storing eight pixels and designated in a predetermined order from 8 to 15. To calculate the difference between the current MB stored in the first register group 102 and the reference MB stored in the second register group 106, the SAD and motion vectors MV for a current reference block are calculated using the following equation.

$$S A D ( ⅆ x , ⅆ y ) = {\sum }_{m = x}^{x + N - 1} {\sum }_{n = y}^{y + N - 1} \vert {I}_{k} ( m , n ) - {I}_{k - 1} ( m + ⅆ x , n + ⅆ y ) \vert \\ \begin{matrix}( M V x , M V y ) = min & S A D ( ⅆ x , ⅆ y )\end{matrix}$$

$$( ⅆ x , ⅆ y ) ∈ {R}^{2}$$

where, k(m,n) is the pixel value of the k-th frame at (M,N). The motion vector (MVx, MVy) represents the displacement of the current block to the best match in the reference frame.

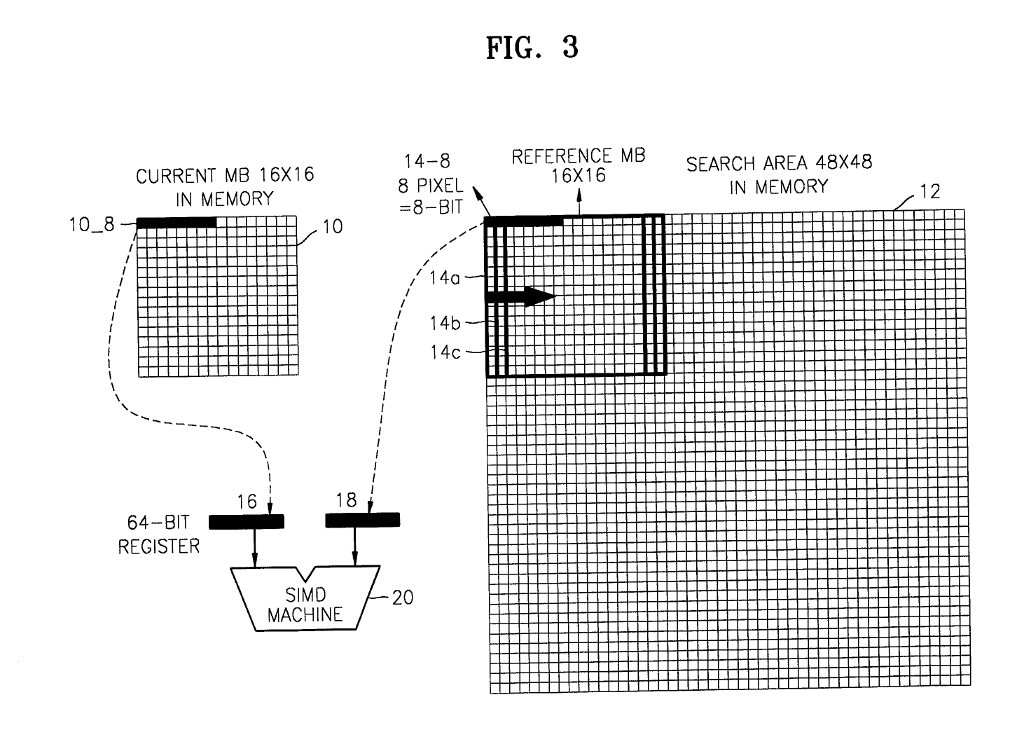

The dissimilarity computing unit 110 (FIG. 4) computes the differences of 8 pixels at the same time using the Single Instruction Multiple Data (SIMD) method in FIG. 3.

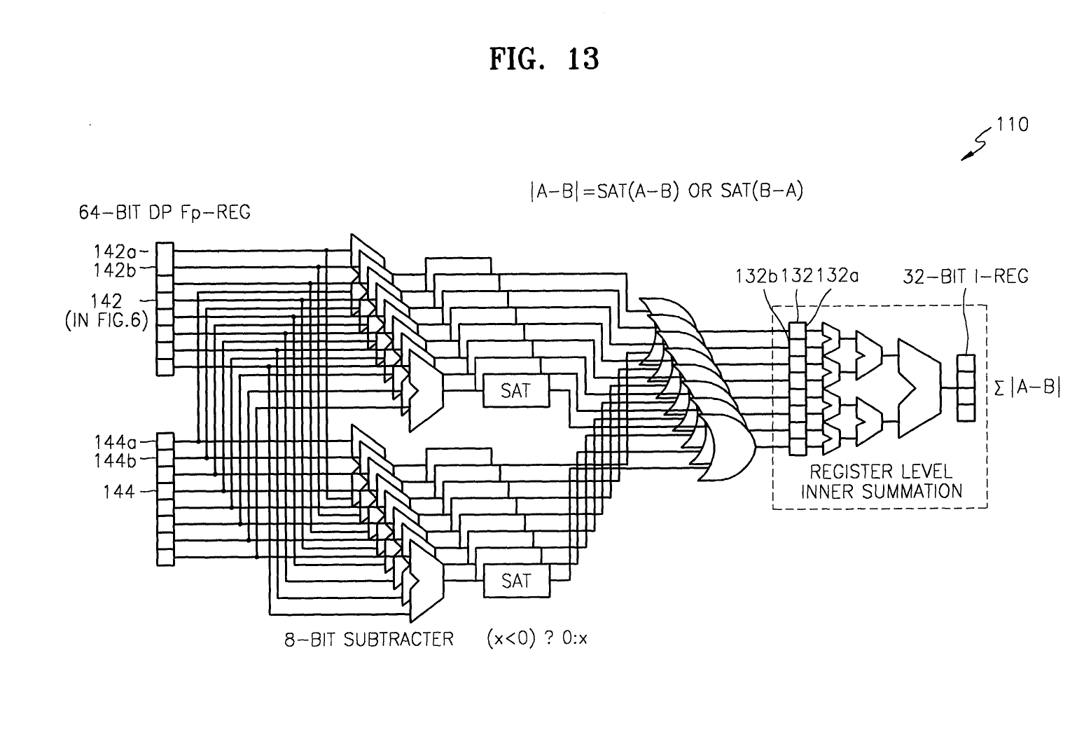

FIG. 13 shows conceptually the dissimilarity computing unit 110 of FIG. 4. An absolute difference value between each pixel of each register 142 of the first register group 102 and each pixel of each register 144 of the second register group 106 is stored in a register 132. For example, the absolute difference value between 142a and 144b is stored in 132a, and the absolute difference value between 142b and 144b is stored in 132b. To calculate the absolute difference between 142 and 144, one inner sum instruction is carried out adding each difference value stored in a register 132 in dotted block of FIG. 13.

As shown in the dotted block of FIG. 13, one inner sum instruction is carried out using only multiple adders. In the conventional method in order to add each value, a summation is carried out using an add instruction and shift instruction, therefore additional cycles are required compared with the present method. Thus, to calculate the matching block wholly between the decimated current MB and the decimated reference MB eight inner sum instructions are carried out.

Once the SADs for all the pixels of the current MB 10 and the reference MB 14 are computed, an internal sum for the reference MB 14a is calculated by adding up the SADs for each pixel. After the internal sum for all the reference MBs of the search area 12 are calculated, the reference MB having the least internal sum is identified as the matching block, and the result of the computation is output as a difference of MB (E_MB) in FIG. 4. The controller 108 in FIG. 4 controls how the reference MB window is shifted in the search area 104 using the SIMD scanning method to reduce the number of memory accesses.

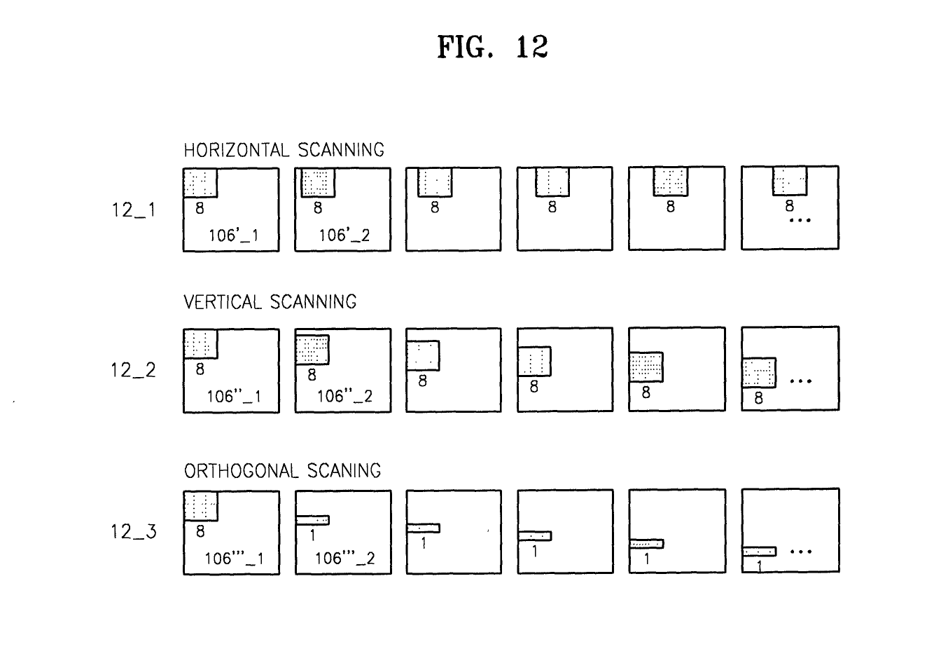

FIG. 12 shows in more detail some differences between conventional scanning methods and the scanning method according to the invention. For a full search, according to the conventional scanning method, a next reference block is shifted from a current reference block by one pixel in a horizontal or vertical direction, as shown in FIGS. 12_1 and 12_2, respectively. In these cases, most pixels in the currently compared reference block overlap with the pixels used in a next compared reference block.

For the horizontal scanning shown in FIG. 12_1, only the far right region of the next register group 106′_2 includes new pixels from those pixels in register group 106′_1. Likewise, for the vertical scanning shown in FIG. 12_2, only the lower region of the next register group 106″_2 includes new pixels compared with the current register group 106″_1. Even though only the edge regions include new pixels, memory accesses are performed for the entire reference macroblock 106.

A vertical scanning for SIMD scheme according to the present invention is shown in FIG. 12_3. Only new pixels 106′″_2 are loaded from main memory into the second register group 106 in FIG. 4. As shown in FIG. 7, the second register group 160b reuses the overlapping pixels stored in register regions 9 through 15 of the first register group 160a. Only the first register region 8 of the second register group 160a is loaded with a new row of pixel values. The first register region 8 is moved down to the last position in the second register group 160b. The other register regions 9-15 that store rows of pixels that overlap with a next reference block are moved up in the sequence by one. For example, register region 9 is moved to a first position, register 10 is moved to a second position, register 11 is moved to a third position, etc.

This shifting of the reference MB requires only one memory access to read a new nonoverlapping row of pixels for each vertical shift in the search area 104 (FIG. 4). Since the entire 8×8 pixel array for the next reference MB does not have to be read from memory, the number of memory accesses for scanning the search area 104 is reduced.

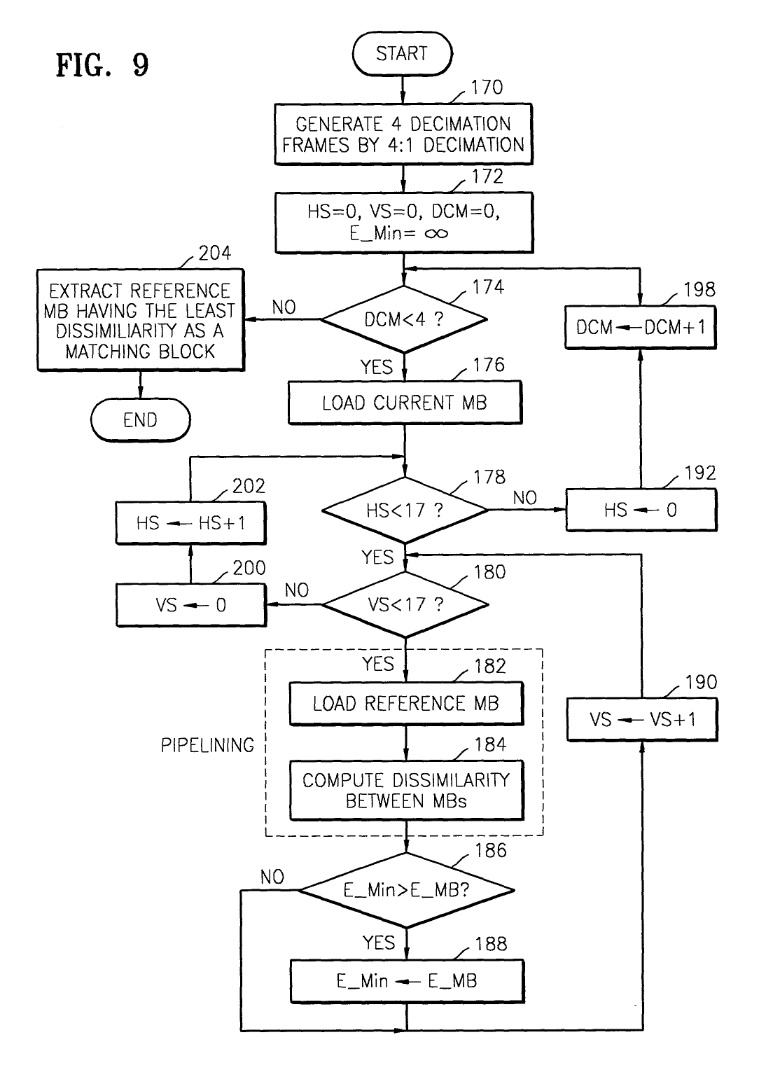

FIG. 8 shows the shifting of the reference MB in the search area 104. The reference MB window is vertically scanned under the control of the controller 108 in FIG. 4. The reference MB window is vertically shifted by one row of pixels at a time. While this shows vertical window shifting, the same technique can be used for horizontal window shifting. Horizontal shifting could be used when pixels are stored in sequential locations in memory along vertical columns of the current and reference frames.

As described above, when registers capable of storing data for one MB are used and a reference MB window is vertically shifted in a search area, overlapping pixels between a current reference MB and a next reference MB are reused. This reduces the number of memory accesses required by the controller 108 to scan the search area. The current MB is stored in the first register group, and the current reference MB is stored in the second register group.

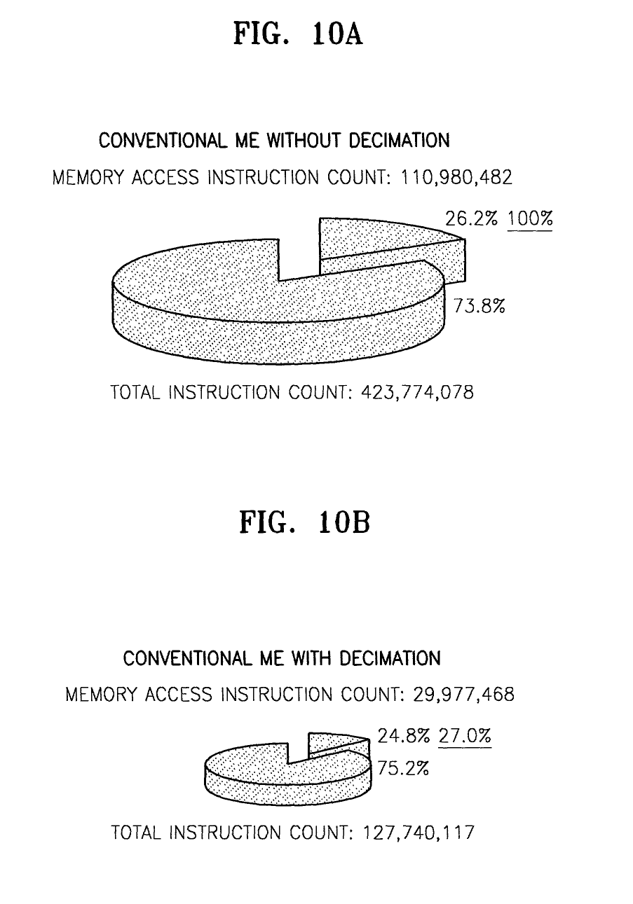

FIG. 9 is a flowchart showing in more detail the SIMD scanning scheme according to the present invention. A current frame and a reference frame are decimated in a ratio of n:1 in step 170. For convenience of explanation, n=4 in the present embodiment. A parameter HS indicates the position of the last column of the first reference MB in the search area, a parameter VS indicates the position of the last low of the first reference MB in the search area, and a parameter DCM indicates four decimation frames.

Here, the first reference MB is the left uppermost MB in the search area, and the first parameter HS and the second parameter VS for the first reference MB are zero. In step 172, the parameters HS, VS, DCM are all initialized to zero, and a minimum dissimilarity E_MIN is initialized with a value as large as possible, for example, infinity.

Identification Nos. 0, 1, 2, and 3 are assigned to the four decimation frames, respectively. The parameter DCM is compared to the value 4 in step 174 to determine whether motion estimation is completed for the last decimation frame. If motion estimation is not completed for the last decimation frame, a current MB is loaded into the first register group 140 (see FIG. 7) in step 176.

It is determined in step 178 whether the HS parameter is less than 17. When the HS parameter is not less than 17, the motion estimation is completed for the last column (HS16) in the search area. HS is reset to zero in step 192 and DCM is incremented to the next DCM frame in block 198. The process then returns to step 174.

If motion estimation is not completed up to HS16, it is determined whether the VS parameter is less than 17 in step 180. If VS is less than 17, a pipelining procedure is performed in steps 182 and 184. Only the last row VS1 is loaded into the reference MB in step 182 (see FIG. 8). If the motion estimation is not completed up to the last low, i.e., if a reference MB window is not shifted to the last row VS16, the reference MB is loaded into the second register group 160a in step 182. The difference between the current MB and the reference MB is calculated in step 184.

In this case, the new row VS1 in the vertical direction is stored in the first register position in the sequence of register regions. For example, $register 8 of the second register group 160a is loaded with the next new nonoverlapping row of pixels for the next reference MB. The other register regions, i.e., $register 9 through $register15, are moved up in the sequence by one. That is, the second register group 106b in FIG. 7 reuses the pixels stored in the register regions $register9 through $register15. Thus, only the pixels of the new row VS1 (FIG. 8) are accessed from memory and stored in the register region $register8 of the second register group 160a.

In step 184, the difference between MBs loaded into the first and second register groups 140 and 160 in FIG. 7 are computed. The MB dissimilarity E_MB is compared with the minimum dissimilarity E_MIN in step 186. If the MB dissimilarity E_MB is less than the minimum dissimilarity E_MIN, the minimum dissimilarity E_MIN is set to the MB dissimilarity E_MB in step 188. If the MB dissimilarity E_MB is not less than the minimum dissimilarity E_MIN, the current minimal dissimilarity E_MIN is maintained, and the parameter VS is incremented in step 190. Then steps 180 through 190 are repeated until vertical scanning of the reference MB reaches the last low VS16 (FIG. 8).

If it is determined in step 180 that the second parameter VS is not less than 17 as a result of scanning the last row VS16, the parameter VS is initialized to zero in step 200. The parameter HS is incremented in step 202, and the process returns to step 178. In other words, the reference MB window is shifted one pixel position to the right. Steps 180-190 are then repeated.

After the reference MB window is shifted in a horizontal direction to the last column HS16, i.e., if it is determined in step 178 that the parameter HS is not less than 17, the first parameter HS is reinitialized to zero in step 192. The DCM parameter is incremented in step 198 and the process returns to step 174. Incrementing the DCM parameter means that motion estimation for another decimation frame is performed.

When motion estimation is completed for all the decimation frames, i.e., if it is determined in step 174 that the DCM parameter is not less than 4, the reference MB with the least dissimilarity is identified as the matching block in step 204. Motion estimation for the current frame is completed by repeating the processes described above for all the MBs of the current frame.

As described above, the first and second register groups store a current MB and a reference MB. The reference MB window is vertically shifted in a search area for motion estimation. Overlapping pixels between a current reference MB and a next reference MB are reused. As a result, fewer instructions (Load/Store) are required when loading the next reference MB into the second register groups. This allows faster motion estimation with less power consumption.

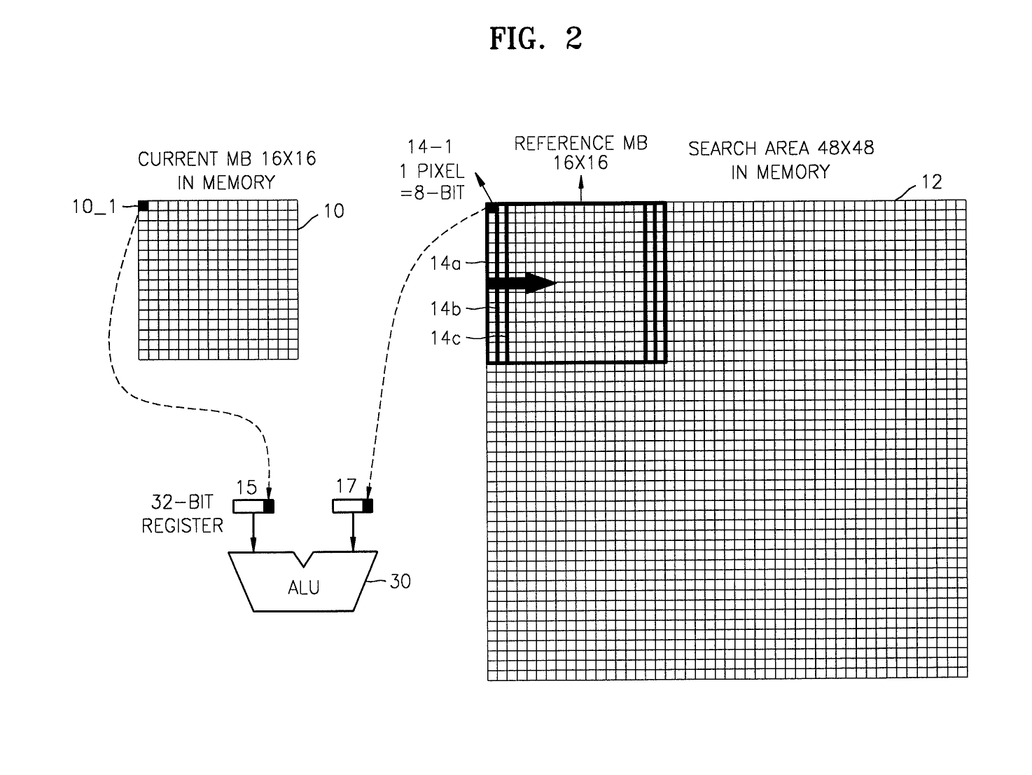

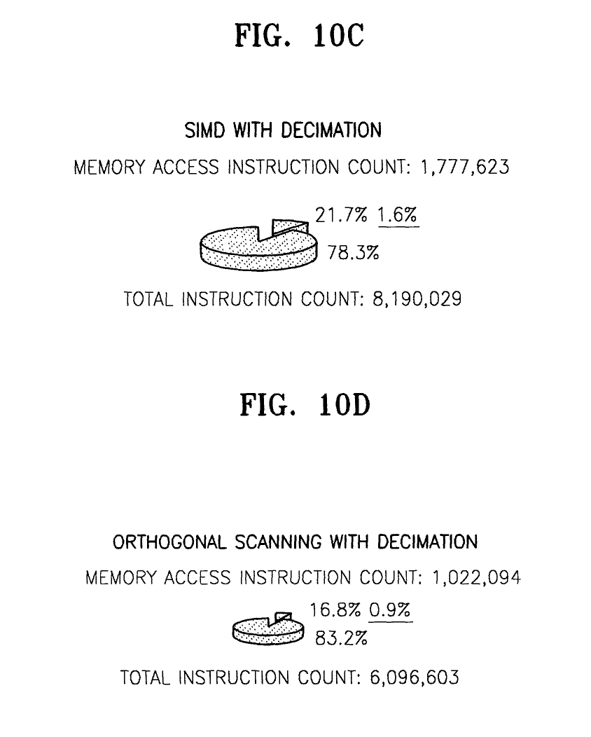

FIGS. 10a through 10d show the advantages of the present invention over conventional motion estimation methods. FIG. 10a identifies the instruction count for a conventional motion estimation method in which decimation is not performed, i.e., full search algorithm. It was determined that 26.2% of the total instruction count for the conventional method of FIG. 10a is required for memory access instruction and the remaining 73.8% of the instruction counts are for non-memory accessing. FIG. 10a corresponds to FIG. 2 where a reference MB is horizontally shifted in a search area and motion estimation is carried out using SAD for each pixel. FIG. 10b shows total instruction count for a conventional motion estimation method where decimation is performed. FIG. 10c shows the total instruction count for conventional motion estimation in which decimation and SIMD are used.

FIG. 10d shows the total instruction count for the motion estimation using the present invention. For the three cases shown in FIGS. 10b through 10d, the percentages 27.0%, 1.6%, and 0.9%, respectively, are a relative ratio of the memory access instruction counts compared with the conventional motion estimation method of FIG. 10a. It is apparent that the orthogonal scanning method to access the non-overlapped portion is the most efficient technique for reducing the memory access count.

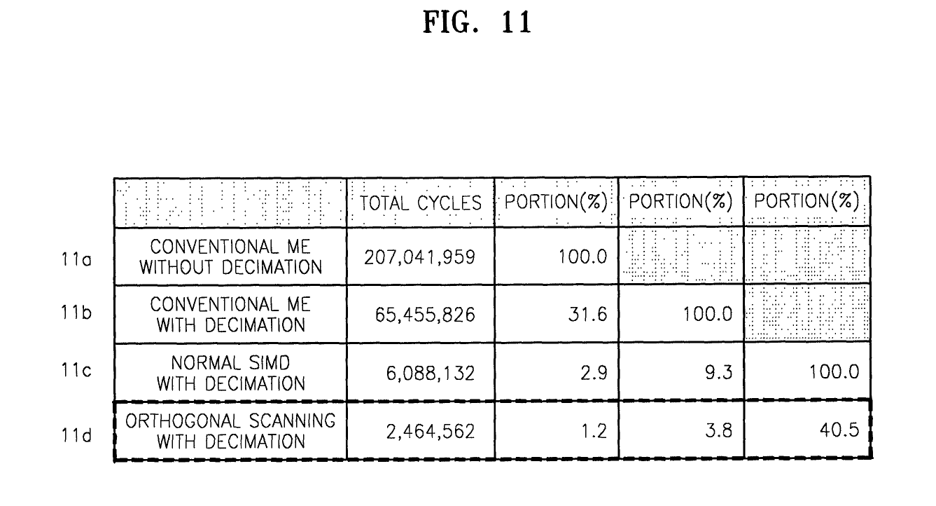

FIG. 11 shows the number of total clock cycles required for 2 frames having the Quarter Common Intermediate Format (QCIF) required to extract 99 minimum SADs. In FIGS. 11, 11a corresponds to FIGS. 10a, 11b corresponds to FIGS. 10b, 11c corresponds to FIGS. 10c, and 11d corresponds to FIG. 10d. The performance of the orthogonal scanning scheme to access the non-overlapped portion is twice the improvement over the conventional motion estimation method using normal SIMD.

The scanning technique described above can be implemented with a Single Instruction Multiple Data (SIMD) device or a Very Long Instruction Word (VLIW) device for comparing the current macroblock with the reference macroblock. The scheme used for matching macroblocks can include a Mean of the Absolute Difference (MAD), Mean of the Absolute Error (MAE), or Sum of the Absolute Difference (SAD) scheme. The method for selecting the next reference macroblock can include a fast algorithm or full search algorithm. Of course, other single instruction/multi-data devices, matching schemes, and searching algorithms can also be used.

The invention may be embodied in a general purpose digital computer by running a program from a computer usable medium, including but not limited to storage media such as magnetic storage media (e.g., ROM's, floppy disks, hard disks, etc.), optically readable media (e.g., CD-ROMs, DVDs, etc.) and carrier waves (e.g., transmissions over the Internet). The computer usable medium can be stored and executed in distributed computer systems connected by a network.

The system described above can use dedicated processor systems, micro controllers, programmable logic devices, or microprocessors that perform some or all of the operations. Some of the operations described above may be implemented in software and other operations may be implemented in hardware.

For the sake of convenience, the operations are described as various interconnected functional blocks or distinct software modules. This is not necessary, however, and there may be cases where these functional blocks or modules are equivalently aggregated into a single logic device, program or operation with unclear boundaries. In any event, the functional blocks and software modules or features of the flexible interface can be implemented by themselves, or in combination with other operations in either hardware or software.

Having described and illustrated the principles of the invention in a preferred embodiment thereof, it should be apparent that the invention may be modified in arrangement and detail without departing from such principles. Claimed are all modifications and variations coming within the spirit and scope of the following claims.

1. An image processing apparatus, comprising:
a first storage element adapted to store a current macroblock;
a second storage element adapted to store a first reference macroblock;
a computing unit to compute a difference between contents of the first storage element and the second storage element; and
a controller adapted to load a second reference macroblock into the second storage element by replacing a nonoverlapping portion of the first reference macroblock with a nonoverlapping portion of the second reference macroblock.

2. An image processing apparatus of claim 1 wherein results of the computing unit are used for determining a motion vector.

3. An image processing circuit of claim 1 wherein the computing unit includes a Single Instruction Multiple Data (SIMD) device.

4. An image processing apparatus according to claim 1 wherein portions of the first reference macroblock that are overlapping with portions of the second reference macroblock are reused in the second storage element by the computing unit to compute the difference between the first storage element and the second storage element.

5. An image processing apparatus according to claim 1 wherein the first storage element comprises multiple registers each storing a group of pixel values for the current macroblock and the second storage element comprises multiple registers storing a group of pixel values for the first reference macroblock.

6. An image processing apparatus according to claim 5 wherein the computing unit compares the group of pixel values stored in each register of the first storage element with the group of pixels values stored in each register of the second storage element at the same time.

7. An image processing apparatus according to claim 5 wherein each one of the multiple registers in the first storage element stores a row or a column of the current macroblock and each one of the multiple registers in the second storage element stores a row or a column of the first reference macroblock.

8. An image processing apparatus according to claim 1 wherein the nonoverlapping portion of the second reference macroblock is loaded from a memory into the second storage element.

9. An image processing apparatus according to claim 1 wherein the controller loads the second reference macroblock into the second storage element by moving a first register position storing nonoverlapping portion to a last register position in the second storage element and moving up in order other registers in the second storage element storing overlapping portions of the first reference macroblock.

10. An image processing apparatus according to claim 1 including a preprocessor that decimates a current frame into multiple decimated current frames and decimates a reference frame into multiple decimated reference frames.

11. An image processing apparatus according to claim 1 wherein the controller and the computing unit are implemented in either software or hardware.

12. An image processing apparatus according to claim 5 wherein the computing unit includes:
a third storage element adapted to store absolute differences between each pixel of each register of the first storage element and each pixel of each register of the second storage element; and
a summation circuit for deriving a summation for the absolute difference values stored in the third storage element.

13. An image processing apparatus according to claim 12 wherein the summation circuit comprises only multiple adders.

14. An image processing apparatus according to claim 12 wherein a single inner sum instruction causes the summation circuit to generate the summation for all of the absolute difference values stored in the third storage element.

15. A motion estimation method, comprising:
loading a current macroblock;
loading a current reference macroblock;
comparing the current macroblock with the current reference macroblock; and loading a next reference macroblock by replacing a nonoverlapping portion of the loaded current reference macroblock with a nonoverlapping portion of the next reference macroblock.

16. A method according to claim 15 including reusing an overlapping portion of the current reference macroblock for comparing the next reference macroblock with the current macroblock.

17. A method according to claim 15 including:
loading in one instruction a nonoverlapping group of pixels from the next reference macroblock into an identified register that currently contains a nonoverlapping portion of pixels for the current reference macroblock; and
reusing pixels in other registers that overlap with the next reference macroblock.

18. A method according to claim 17 including loading the identified register from a memory storing a reference frame.

19. A method according to claim 17 including moving an order of the identified register storing the nonoverlapping protion of the next reference macroblock to a last register position and moving up the order of the other registers.

20. A method according to claim 15 including comparing each group of pixel values for the loaded current macroblock with each group of pixel values for the loaded current reference macroblock at the same time.

21. A method according to claim 20 wherein the group of pixel values each comprise a row or column of the current macroblock or a row or column of the current reference macroblock.

22. A method according to claim 15 including using a Single Instruction Multiple Data (SIMD) device or a Very Long Instruction Word (VLIW) device for comparing the current macroblock with the current reference macroblock.

23. A method according to claim 15 including comparing the current macroblock with the current reference macroblock using a matching macroblock scheme.

24. A method according to claim 23 wherein the matching macroblock scheme is Mean of the Absolute Difference (MAD), Mean of the Absolute Error (MAE), or the Sum of the Absolute Difference (SAD).

25. A method according to claim 15 including selecting the next reference macroblock using a fast algorithm or full search algorithm.

26. A method according to claim 15 including:
decimating a current frame into multiple decimated current frames;
decimating a reference frame into multiple decimated reference frames;
selecting the current macroblock from the decimated current frames;
shifting the selected current macroblock over search areas of the decimated reference frames to identify a reference macroblock most similar to the current macroblock; and
deriving a motion vector for the identified reference macroblock.

27. A method according to claim 20 including:
storing absolute differences between each group of pixel values for the loaded current macroblock with each group of pixel values for the loaded current reference macroblock; and
deriving a summation of the absolute difference values.

28. A method according to claim 27 including using only adders to derive the summation for the absolute difference values.

29. A method according to claim 28 including using a single inner sum instruction to generate the summation for all of the absolute difference values.
